(19) United States
(12) Patent Application Publication
(10) Pub. No.: US 2008/0000027 A1
(43) Pub. Date: Jan. 3, 2008

(54) Adjustable bed frame

(76) Inventor: Alain Clenet, Solvang, CA (US)

Correspondence Address: John H. Lynn;Suite C 103, 2915 Redhill Avenue, Costa Mesa, CA, 92626, US

(21) Appl. No.: 11/699,759

(22) Filed: Jan. 29, 2007

Related U.S. Application Data
(60) Provisional application No. 60/817,545, filed on Jun. 29, 2006.

(51) Int. Cl. A61G 7/015; A47C 19/00

(52) U.S. Cl. 5/618; 5/200.1

(57) ABSTRACT

A bed frame comprises a lower support structure having a head end and a foot end and a carriage arranged for translational movement on the lower support structure. An upper support structure is mounted on the carriage. The upper support structure includes a seat and an upper body support section pivotally connected thereto. A support arm is pivotally connected between the lower support structure and the upper body support section. An actuator is connected to the lower support structure. A lever arm is connected between the actuator and the carriage. Application of force from the actuator to the lever arm moves the carriage on the lower support structure. The support arm is arranged such that movement of the carriage toward the head end of the lower support structure produces a lifting moment on the upper body support section.

### CROSS REFERENCE TO RELATED APPLICATION

Applicant claims priority based upon U.S. Provisional patent application No. 60/817,545, filed Jun. 29, 2006.

### BACKGROUND OF THE INVENTION

This invention relates generally to furniture and particularly to beds. Still more particularly this invention relates to articulated bed frames.

### SUMMARY OF THE INVENTION

A bed frame according to the present invention comprises a lower support structure having a head end and a foot end and a carriage arranged for translational movement on the lower support structure. The bed frame further includes an upper support structure mounted on the carriage so as to be movable therewith. The upper support structure includes a seat with an upper body support section being pivotally connected to the seat. A support arm has a first end pivotally connected to the lower support structure and a second end pivotally connected to the upper body support section. An actuator is connected to the lower support structure. A lever arm having a first end connected to the actuator and a second end is connected to the carriage. The actuator and lever arm are arranged such that application of force from the actuator to the lever arm provides a motive force for moving the carriage on the lower support structure. The support arm is arranged such that movement of the carriage toward the head end of the lower support structure produces a lifting moment on the upper body support section.

The bed frame according to the present invention preferably also includes a mattress retainer mounted to the upper frame section to prevent a mattress positioned on the upper support structure from moving off the upper support structure.

The upper support structure also includes a thigh support section pivotally connected to the carriage and includes a lower leg support section pivotally connected to the thigh support section. The mattress retainer includes a pair of brackets mounted to the lower leg support section and a retainer bar that is demountably connected to the pair of brackets. The retainer bar having a central portion that extends upward from the lower leg support section when the bed frame is assembled for use. The retainer bar may be mounted in the brackets with the central portion upside down to reduce the height of the bed frame when the bed frame is packaged for shipping.

The bed frame may further comprising a plurality of legs attached to the lower support structure to elevate the bed frame.

The bed frame preferably is formed so that all components thereof are above the lowermost portion of the lower support structure so that the actuator is capable of articulating the upper support structure with the lower support structure being placed upon a floor or a conventional bed frame without any legs being attached to the lower support section.

The bed frame preferably also includes a foam edge connected to the upper support section with the foam edge having a corrugated portion near the pivotal connection between the thigh support section and the lower leg support section. A stretchable fabric may be arranged to cover the foam edge to provide a smooth outer surface of the bed frame for all operational positions of the upper support section.

The bed frame may further include means for lifting the foot end with the same motor used to elevate the head end.

### BRIEF DESCRIPTION OF THE DRAWINGS

FIG. 1 is a simplified side elevation view of an articulated bed frame according to the present invention;

FIG. 2 is a side elevation view showing additional structural features of the invention;

FIG. 3 is a bottom plan view of the articulated bed frame according to the present invention;

FIG. 4 is a perspective view showing a mattress support on the bed frame;

FIG. 5 is a cross sectional view showing a mattress retainer that may be included in the bed frame according to the present invention;

FIG. 6 is a perspective view showing the articulated bed frame according to the present invention;

FIG. 7A is a side elevation view of the articulated bed frame of FIG. 6;

FIG. 7B is a perspective view of a portion of the apparatus of FIG. 7A;

FIG. 7C is a side elevation view showing apparatus for connecting a mattress to the bed frame to restrain the mattress against sliding as the bed frame is articulated;

FIG. 7 D shows an alternative arrangement for connecting the mattress to the bed frame;

FIG. 8 is a side elevation view showing an end of the articulated bed frame of FIG. 6;

FIG. 9 is a side elevation view showing an alternative means for lifting the foot end of the bed frame;

FIG. 10 is a side elevation view showing details of a portion of the apparatus of FIG. 9 for lifting the foot end of the bed frame; and

FIG. 11 is a side elevation view of another structure for lifting the foot end of the bed frame.

### DETAILED DESCRIPTION OF THE INVENTION

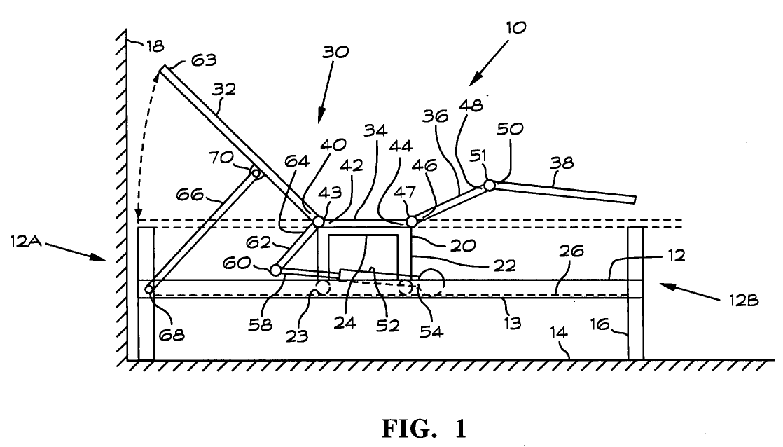

As shown in FIG. 1 a bed 10 according to the present invention includes a lower support structure 12 that is in contact with a floor 14 through a plurality of legs 16 that are preferably removable. The lower support structure 12 has a head end 12A and a foot end 12B.

A carriage 20 is arranged to travel lengthwise on the lower support structure 12. The carriage 20 has a plurality of legs 22 that extend from a platform 24. The legs preferably include rollers 23 arranged to roll upon a pair of lengthwise side rails 26 that are included in the lower support structure 12.

An upper support structure 30 is mounted on the platform 24 so that the upper support structure 30 is movable with the carriage. The upper support structure 30 comprises an upper body support section 32, a seat section 34, a thigh support section 36 and a lower leg support section 38. The seat support section is fixed to the carriage 20 for translation therewith. An edge 40 of the upper body support section 32 is pivotally connected to an edge 42 of the seat support section 34 by a hinge assembly 43. An edge 44 of the thigh support section 34 is pivotally connected to an edge 46 of the seat support section 34 by a hinge assembly 47. An edge 48 of the lower leg support section 36 is pivotally connected to an edge 50 of the seat support section 34 by a hinge assembly 51.

As shown in FIGS. 1-3, a linear actuator 52 has a first end 54 that is pivotally attached to the lower support structure 12. A second end 58 of the linear actuator 52 is pivotally attached to a first end 60 of a lever arm 62. A second end 64 of the lever arm is rigidly attached to the edge 40 of the upper body support section 32. The actuator 52 applies a force to the end 60 of the lever arm 62, which is spaced apart from the pivotal connection between the upper body support section and the seat section.

When the linear actuator 52 pushes on the lever arm 62, the result is a lifting moment on the upper body support section 32. This lifting moment causes the upper body section 32 to rotate clockwise about the hinge 43 that connects the upper body section 32 with the seat support section 34, thus raising an end 63 upper body support section 32. At the same time, the carriage 20, the upper body support section 32, the seat section 34, the thigh support section 36 and the lower leg support section 38 all move toward the wall 18. This movement toward the wall 18 keeps the upper support structure 30 at a nearly constant distance from the wall 18 so that a person on the bed 10 may have easy access to items on a bedside table for all positions of the upper body support section 32.

A support arm 66 has a first end 68 pivotally connected to the lower support structure 12 and a second end 70 pivotally connected to the upper body support section 32. Motion of the carriage 20 toward the head end 12A of the lower support structure 12 exerts a force in the support arm 66 that assists in pivoting the upper body support section lifting the upper body support section 32. The action of motor 52 on arm 62 and arm 66 create a lifting action upon the upper body support section 32.

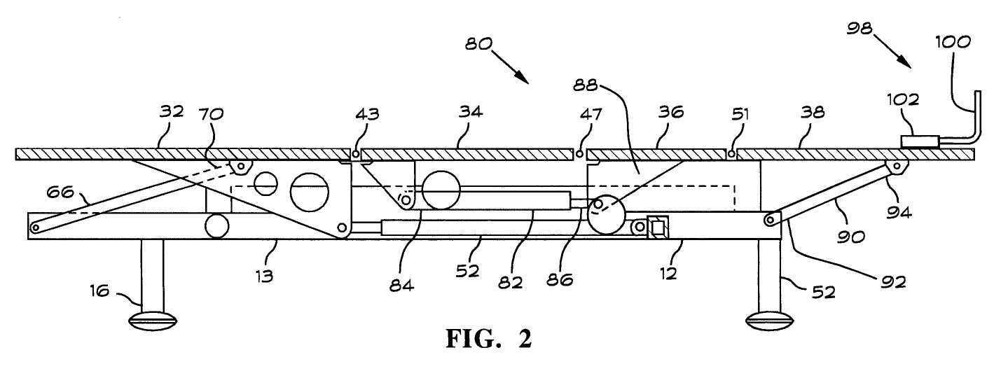

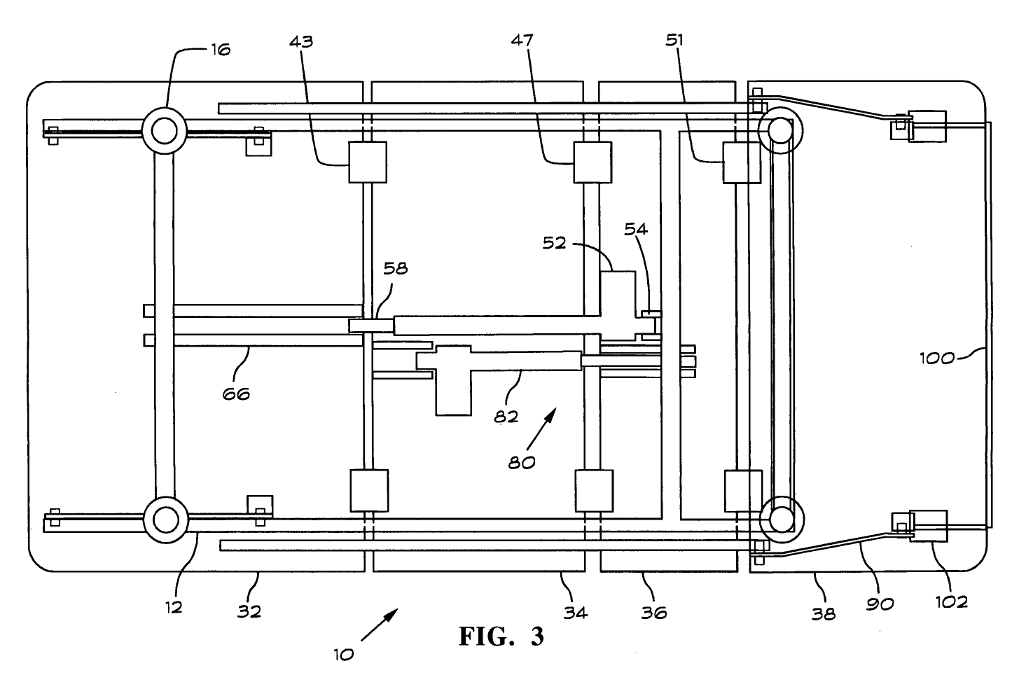

As shown in FIGS. 2 and 3, the bed 10 also preferably includes a lifting mechanism 80 that lifts the thigh support section 36 and the lower leg section 38. U.S. Pat. No. 4,258,445, which issued Mar. 31, 1981 to Zur, discloses a suitable structure for the leg lifting mechanism 80. The disclosure of U.S. Pat. No. 4,258,445 is incorporated by reference into the present disclosure. A brief description of the leg lifting mechanism 80 is included herein so that the entire bed 10 is described.

Referring to FIGS. 2 and 3, a linear actuator 82 has a first end 84 pivotally connected to the seat support 34 and a second end 86 pivotally connected to a bracket 88 that is fixed to the thigh support section 36. A support member 90 has a first end 92 connected to the lower support structure 12 and an upper end 94 connected to the lower leg support section 38. When the linear actuator 82 pushes on the bracket 88 to raise the thigh support section 36, the support member 90 raises the foot end of the lower leg support section 38.

As shown in FIGS. 2 and 3, the bed 10 may include a mattress retainer 98 connected to the lower leg support section 38. The mattress retainer 98 includes a retainer bar 100 that is connected to a bracket 102 that is in turn secured to the lower leg section 38. The retainer bar 100 is arranged to extend vertically above the foot end of the lower leg section 38 when the frame 12 is fully assembled. The retainer bar 100 may arranged to extend downward as shown in the dashed lines 100A of FIG. 2 to make the bed frame as compact as possible for shipping in a container such as cardboard box (not shown). The legs 16 are formed for easy attachment and removal from the frame 12, which also contributes to making the frame 12 easier and less expensive to ship from a factory or warehouse to a customer.

It should be noted that other than the legs 16, no structural features of the frame 12 extend below the lowermost frame member 13 for any position of the upper support structure 30. The legs 16 are an option feature of the bed frame 12, which may be used without them. This feature permits use of the frame 12 without the legs 16 being attached so that the frame 12 will function properly when placed directly on any horizontal support such as the floor 14 or an existing bed frame (not shown).

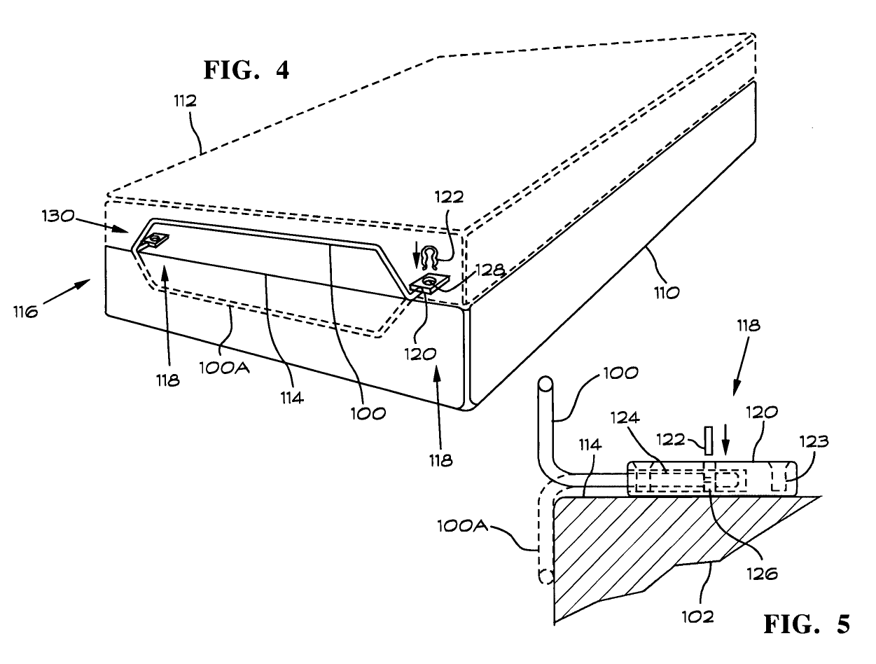

As shown in FIG. 4, the bed 10 may include a mattress platform 110 that supports a mattress 112. The mattress platform 110 has a foot end 114. As shown in FIGS. 4 and 5, a mattress retainer 116 is mounted to the mattress platform 110 by a pair of bracket assemblies 118. Each of the bracket assemblies 118 includes an injection molded receptacle 120 and a retainer clip 122. Screws 123 may be used to secure the receptacle to the mattress platform. The mattress retainer 116 includes a pair of rods 124 that extend into a cylindrical passage 126 in the receptacle 120. The rods 124 have a reduced diameter portion 126 where the retainer clips 122 may be inserted into passages 128 to engage the reduced diameter portions 126 and thereby retain the rods 124 with the passages 126.

A retainer bar 130 extends between the rods 124 and has a portion 132 that extends vertically from the mattress platform 110 a distance sufficient to prevent the foot end 114 from sliding lengthwise off the mattress platform 110.

The mattress retainer 116 is designed so that the mattress platform 110 may be made as compact as possible for shipping. Normally the mattress platform 110 is to be shipped with the retainer bar portion arranged to extend downward as indicated by the dashed lines 132A. The clips 122 are removed from the retainers 120 so that the rods 124 may be removed from the receptacles 120. The clips 122 may be removed and reinserted into the receptacles 120 without requiring the use of any tools. The retainer bar 130 is then turned over so that the retainer bar 130 is in its upward position to retain the mattress in position as described above.

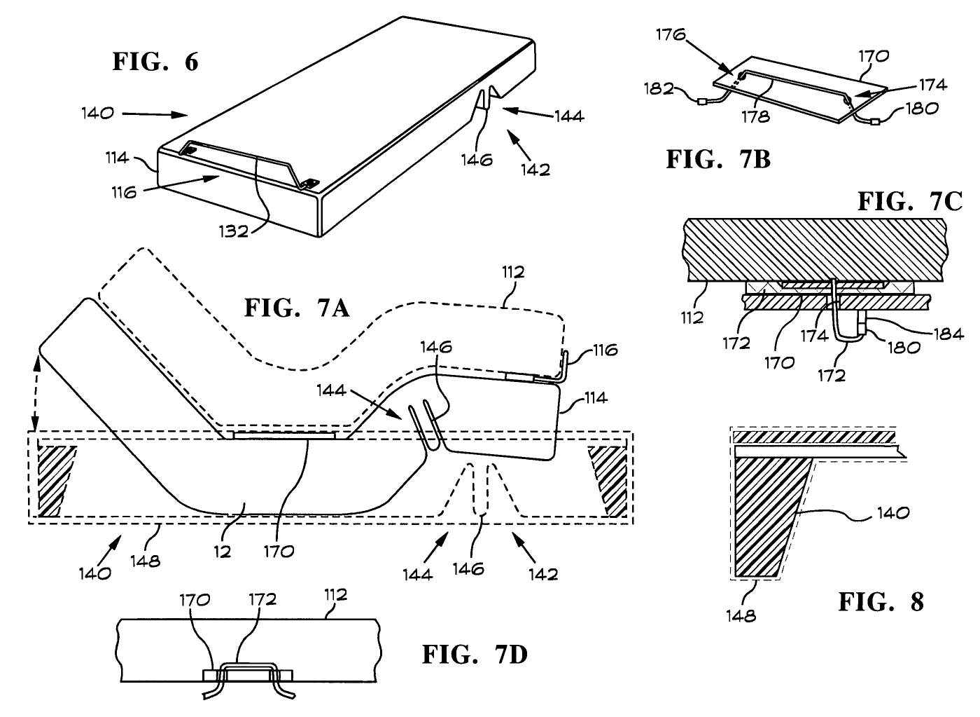

FIGS. 6, 7A and 8 illustrate additional features of the bed 10 according to the present invention. FIG. 8 shows a foam edge 140 of the frame 12. A bottom portion 142 has a plurality of troughs 144 therein that extend across the foam edge 140. As shown in the elevation view of FIG. 7A, the troughs 144 each have a generally triangular cross section so that the bottom portion 142 of the foam edge 140 has a generally corrugated configuration. FIGS. 6 and 7A show the foam edge 140 having two parallel troughs 144 with a projection 146 extending between them. When the thigh support section 36 of the upper support structure 30 becomes elevated, the lower leg support section 38 pivots about the hinge assembly 51 so that the foot end of the bed is lower that the hinge assembly 51. As the lower leg support pivots relative to the thigh support section 36, the mattress 140 folds at the bottom portion 142 so that the widths of the troughs decreases as shown in FIG. 7A. The corrugated effect created by the troughs 144 prevents the foam edge 140 from buckling as it folds from its flat position shown in FIG. 6 and in the dashed lines of FIG. 7 to the folded configuration shown in solid lines in FIG. 7.

The foam edge 140 may include a fabric 148 that covers the foam so that the troughs 144 are not visible and so that the edges of the mattress 140 appear to be a smooth line.

FIGS. 7A-7C illustrate an alternative means for retaining the mattress 112 in the desired position on the frame. It is well-known that as the frame 10 adjusts into different configurations, there is a tendency for the mattress 112 to move toward the foot end.

FIG. 7A shows a flat member 170 connected to the bottom side of the mattress 112. The flat member 170 may be formed of materials such as wood, plastic, metal etc. and is preferably secured to the mattress with an adhesive. To prevent the flat member 170 from separating from the mattress 112, a layer of mesh 172 may be used to cover the flat member 170 as shown in FIG. 7C.

As shown in FIG. 7B, a pair of holes 174 and 176 are formed in the flat member 170. A cord 178 passes through the holes 174 and 176. The cord 178 has snap fasteners 180 and 182 connected to its ends. As shown in FIG. 7C, the snap fastener 180 may be connected to a snap receptacle 184 that is attached to the platform 34. The snap fastener 182 is connected to a similar snap receptacle (not shown). The cord 178 may be formed as a ribbon, rope, cable or the like. Having the cord 178 fastened to the platform 34 restrains the mattress 112 against vertical movement (bridging) relative to the platform 34 as the mattress position is adjusted to raise the head and foot sections.

The flat member 170 may alternatively be integrated into the foam mattress structure 112 as shown in FIG. 7D.

FIG. 9 shows an alternative means for raising and lowering the thigh support section 36 and the lower leg support section 38 using the motor 52. As the upper support structure 20 moves translationally to the left as seen in FIG. 9 over the lower structure 12, the bracket 88 comes into contact with a detent 150. The detent 150 is shown as a wheel 151 that is mounted on the lower structure 12 by a bracket 152. The timing of the lifting of the foot end is determined by the location of the wheel 151 on the lower structure 12.

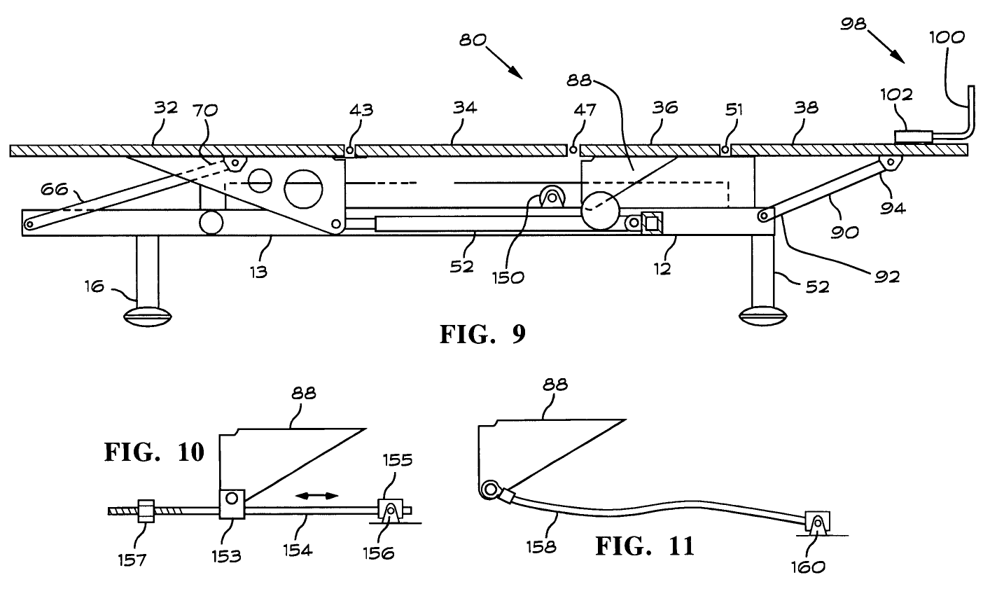

Referring to FIG. 10 the detent 150 may be formed as a cube 153 attached to bracket 88. A bar 154 is arranged to slide through a passage in the cube 153. The bar 154 has an end 155 that is rotatably attached to the lower structure 12 by a bracket assembly 156. A nut 157 is mounted on a threaded portion of the bar 154. When the upper support structure moves to the let as seen in FIG. 9, the bracket 88 moves toward the nut 157. When the bracket 88 contacts the nut 157, the foot end of the bed frame begins to elevate. The position of the nut 157 may be varied to control the timing of the lifting of the foot end of the bed.

FIG. 11 shows another means for lifting the foot end of the bed. A cable 158 is connected between the bracket 88 and a bracket 160. The bracket 160 is mounted to the lower structure 12 so that tension in the cable 158 pulls the foot end into an elevated position.

From the foregoing, it is readily apparent that the present invention comprises a new, unique, and exceedingly useful bed frame that constitutes a considerable improvement over the known prior art. Many modifications and variations of the present invention are possible in light of the above teachings. It is to be understood that within the scope of the appended claims the invention may be practiced otherwise than as specifically described.

What is claimed is:

1. A bed frame, comprising:
a lower support structure having a head end and a foot end;
a carriage arranged for translational movement on the lower support structure;
an upper support structure mounted on the carriage so as to be movable therewith, the upper support structure including a seat and an upper body support section pivotally connected to the seat;
a support arm having a first end pivotally connected to the lower support structure and a second end pivotally connected to the upper body support section;
an actuator connected to the lower support structure; and
a lever arm having a first end connected to the actuator and a second end connected to the upper body support structure, the actuator and lever arm being arranged such that application of force from the actuator to the lever arm provides a motive force for moving the carriage and the upper support structure on the lower support structure, the support arm being arranged such that movement of the carriage toward the head end of the lower support structure produces a support arm causes a lifting moment on the upper body support section.

2. The bed frame of claim 1, further comprising a mattress retainer mounted to the upper frame section to prevent a mattress positioned on the upper support structure from moving off the upper support structure.

3. The bed frame of claim 1 wherein the upper support structure also includes a thigh support section pivotally connected to the carriage and a lower leg support section pivotally connected to the thigh support section and wherein the mattress retainer includes a pair of brackets mounted to the lower leg support section and a retainer bar that is demountably connected to the pair of brackets, the retainer bar having a central portion that extends upward from the lower leg support section when the bed frame is assembled for use, the retainer bar being mounted in the brackets with the central portion upside down to reduce the height of the bed frame when the bed frame is packaged for shipping.

4. The bed frame of claim 1, further comprising a plurality of legs attached to the lower support structure to elevate the bed frame.

5. The bed frame of claim 1 wherein all components of the bed frame are above the lowermost portion of the lower support structure so that the actuator is capable of articulating the upper support structure with the lower support structure being placed upon a floor without any legs being attached to the lower support section.

6. The bed frame of claim 1 wherein all components of the bed frame are above the lowermost portion of the lower support structure so that the actuator is capable of articulating the upper support structure with the lower support structure being placed upon a conventional unarticulated bed frame.

7. The bed frame of claim 1 further comprising:
a foam edge connected to the upper support section, the foam edge having a corrugated portion near the pivotal connection between the thigh support section and the lower leg support section; and
a stretchable fabric arranged to cover the foam edge to provide a smooth outer surface of the bed frame for all operational positions of the upper support section.

8. The bed frame of claim 3, further comprising retainer means for restraining the foot end of the upper support structure against translational movement toward the head end so that translational movement of the seat portion toward the head end causes the foot end of the bed frame to elevate.

9. The bed frame of claim 8 wherein the retainer means includes a bracket attached to the thigh support and a detent attached to the lower support structure such that pressure between the bracket and the detent lifts the thigh and foot support sections.

10. The bed frame of claim 8 wherein the retainer means includes a first bracket connected to the thigh support section, a second bracket connected to the lower support section and a cable connected between the first and second bracket so that tension in the cable lifts the thigh and foot support sections.

11. An articulated bed, comprising:
a lower support structure having a head end and a foot end;
a carriage arranged for translational movement on the lower support structure;
an upper support structure mounted on the carriage so as to be movable therewith, the upper support structure including a seat and an upper body support section pivotally connected to the seat;
a mattress arranged to be supported by upper support structure; and
a mattress retainer assembly connected between the mattress and the upper support structure to restrain a central portion of the mattress against movement relative to the upper support structure as the mattress and frame articulate.
